(19) United States
(12) Patent Application Publication
(10) Pub. No.: US 2020/0124781 A1
(43) Pub. Date: Apr. 23, 2020

(54) LIGHT CONVERSION LAYER, BACKLIGHT MODULE, AND DISPLAY DEVICE INCLUDING THE SAME

(71) Applicant: Unique Materials Co., Ltd., Taipei City (TW)

(72) Inventors: Huan-Wei Tseng, Taipei City (TW); Chun-Wei Chou, Taipei City (TW); Ting-Chia Yang, Taipei City (TW); Yi-Lin Yu, Taipei City (TW)

(73) Assignee: Unique Materials Co., Ltd., Taipei City (TW)

(21) Appl. No.: 16/659,577

(22) Filed: Oct. 22, 2019

Related U.S. Application Data
(60) Provisional application No. 62/748,534, filed on Oct. 22, 2018.

(51) Int. Cl. F21V 8/00; C09K 11/02; C09K 11/88

(52) U.S. Cl. CPC G02B 6/005; C09K 11/883; C09K 11/02; G02B 6/0046

(57) ABSTRACT

Provided is a backlight module including a light source, a light guide plate, and a light conversion layer. The light source emits light. The light guide plate is optically coupled to the light source and the light transmits through the light guide plate. The light conversion layer is disposed on the light guide plate. The light conversion layer includes a first layer and a second layer. The first layer is adjacent to the light source and includes a plurality of first quantum dots. The second layer is further away from the light source than the first layer and includes a plurality of second quantum dots. An emission wavelength of the plurality of first quantum dots is greater than an emission wavelength of the plurality of second quantum dots.

### CROSS-REFERENCE TO RELATED APPLICATIONS

This application claims the priority benefit of U.S. provisional application Ser. No. 62/748,534, filed on Oct. 22, 2018. The entirety of the above-mentioned patent application is hereby incorporated by reference herein and made a part of this specification.

### BACKGROUND OF THE INVENTION

### Field of the Invention

The invention relates to a light conversion layer, a backlight module, and a display device including the same.

### Description of Related Art

Quantum dots are very small semiconductor nanostructures that are invisible to the naked eye. When quantum dots are stimulated by light, the quantum dots emit colored light, which is determined by the composition, size and shape of the quantum dots. This characteristic enables the quantum dots to change the color of light emitted by a light source. In recent years, quantum dot-containing polymer composite materials have been widely used in fields of backlight module and display device, etc.

However, since the quantum dots have the characteristic of absorbing the light with the shorter wavelength than their own peak emission wavelength, when a plurality of quantum dots having different emission wavelengths are mixed in the light-emitting device, the light conversion efficiency of the quantum dots of the light-emitting device is lowered and the complexity of adjusting the white point increases. Based on the above, the present invention needs to resolve these disadvantages to provide a light-emitting device having quantum dots with higher light conversion efficiency.

### SUMMARY OF THE INVENTION

The invention provides a backlight module in which a quantum dot layer having a longer emission wavelength is disposed closer to a light source than a quantum dot layer having a shorter emission wavelength, so as to simplify white point adjustment and increase the light conversion efficiency of the quantum dots-containing backlight module, thereby reducing labor costs and, at the same time, improving energy efficiency and the brightness of the backlight module.

The invention provides a backlight module including a light source, a light guide plate, and a light conversion layer. The light source emits light. The light guide plate is optically coupled to the light source and the light transmits through the light guide plate. The light conversion layer is positioned on the light guide plate. The light conversion layer includes a first layer and a second layer. The first layer is adjacent to the light source and includes a plurality of first quantum dots. The second layer is further away from the light source than the first layer and includes a plurality of second quantum dots. An emission wavelength of the first quantum dots is greater than an emission wavelength of the second quantum dots.

In one embodiment of the invention, the first layer is in direct contact with the second layer, and the first layer and the second layer are sandwiched between two substrates.

In one embodiment of the invention, the backlight module further includes at least one substrate between the first layer and the second layer.

In one embodiment of the invention, the at least one substrate is free of a barrier layer.

In one embodiment of the invention, the backlight module further includes two first substrates, with the first layer sandwiched between the two first substrates; and two second substrates, with the second layer sandwiched between the two second substrates, wherein one of the two first substrate is in direct contact with an adjacent second substrate.

In one embodiment of the invention, the light is a blue light, the plurality of first quantum dots comprise a plurality of red quantum dots, and the plurality of second quantum dots comprise a plurality of green quantum dots.

In one embodiment of the invention, the first layer further includes a first resin material. The plurality of first quantum dots are dispersed and embedded in the first resin material. The first resin material is prepared by a first precursor, and the first precursor includes a first surfactant having a thiol group.

In one embodiment of the invention, the second layer further includes a second resin material. The plurality of second quantum dots are dispersed and embedded in the second resin material. The second resin material is prepared by a second precursor, and the second precursor includes a second surfactant having a thiol group.

In one embodiment of the invention, the first surfactant or the second surfactant has at least two thiol groups.

In one embodiment of the invention, the first surfactant or the second surfactant is a compound represented by formula (I), formula (II) or formula (III) below:

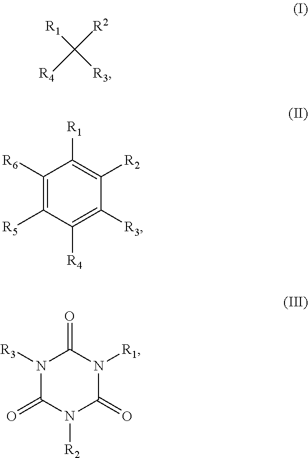

wherein R₁, R₂, R₃, R₄, R₅ and R₆ are the same as or different from one another, and are independently selected from the group consisting of hydrogen, C₁ to C₂₀ alkyl, C₂ to C₂₀ alkenyl, C₂ to C₂₀ alkynyl, C₁ to C₂₀ hydroxy alkyl, C₁ to C₂₀ alkyl ester, C₂ to C₂₀ alkyl ketone, C₁ to C₂₀ alkyl thioether and C₁ to C₂₀ alkoxy, wherein at least two of R₁ to R₄ have a thiol group when the first surfactant or the second surfactant is the compound of formula (I); at least two of R₁ to R₆ have a thiol group when the first surfactant or the second surfactant is the compound of formula (II); and at least two of R₁ to R₃ have a thiol group when the first surfactant or the second surfactant is the compound of formula (III).

In one embodiment of the invention, the first precursor or the second precursor includes: 5 wt % to 30 wt % of the first surfactant or the second surfactant having at least two thiol groups, 30 wt % to 50 wt % of a first acrylate monomer, 15 wt % to 30 wt % of a second acrylate monomer, 5 wt % to 20 wt % of a cross-linker, and 1 wt % to 2 wt % of an initiator.

In one embodiment of the invention, the backlight module further includes a reflective layer disposed below the light guide plate to reflect the light into the light conversion layer.

The invention provides a light conversion layer disposed over a light source. The light conversion layer includes a first layer and a second layer. The first layer is adjacent to the light source and includes a plurality of first quantum dots. The second layer is further away from the light source than the first layer and includes a plurality of second quantum dots. An emission wavelength of the first quantum dots is greater than an emission wavelength of the second quantum dots.

In one embodiment of the invention, the first layer is in direct contact with the second layer, and the first layer and the second layer are sandwiched between two substrates.

In one embodiment of the invention, the light conversion layer further includes at least one substrate between the first layer and the second layer.

In one embodiment of the invention, the at least one substrate is free of a barrier layer.

In one embodiment of the invention, the first layer includes a first resin material. The plurality of first quantum dots are dispersed and embedded in the first resin material. The first resin material is prepared by a first precursor, and the first precursor includes a first surfactant having a thiol group. The second layer includes a second resin material. The plurality of second quantum dots are dispersed and embedded in the second resin material. The second resin material is prepared by a second precursor, and the second precursor includes a second surfactant having a thiol group.

In one embodiment of the invention, the first surfactant or the second surfactant has at least two thiol groups.

In one embodiment of the invention, the first surfactant or the second surfactant is a compound represented by formula (I), formula (II) or formula (III) below:

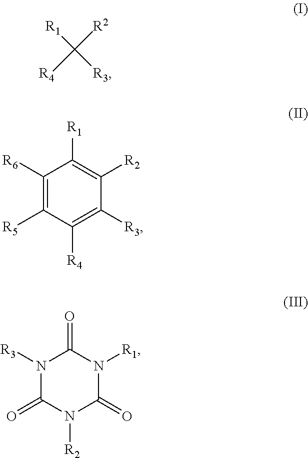

wherein R₁, R₂, R₃, R₄, R₅ and R₆ are the same as or different from one another, and are independently selected from the group consisting of hydrogen, C₁ to C₂₀ alkyl, C₂ to C₂₀ alkenyl, C₂ to C₂₀ alkynyl, C₁ to C₂₀ hydroxy alkyl, C₁ to C₂₀ alkyl ester, C₂ to C₂₀ alkyl ketone, C₁ to C₂₀ alkyl thioether and C₁ to C₂₀ alkoxy, wherein at least two of R₁ to R₄ have a thiol group when the first surfactant or the second surfactant is the compound of formula (I); at least two of R₁ to R₆ have a thiol group when the first surfactant or the second surfactant is the compound of formula (II); and at least two of R₁ to R₃ have a thiol group when the first surfactant or the second surfactant is the compound of formula (III).

The invention provides a display device including a display panel and the backlight module disposed at one side of the display panel.

Based on the above, in the embodiment of the present invention, a plurality of quantum dots having different emission wavelengths are respectively disposed at different levels, so as to prevent the quantum dots with a longer emission wavelength from absorbing the light emitted by the quantum dots with a shorter emission wavelength, thereby preventing the light emitted by the quantum dots having the shorter emission wavelength from being absorbed and converting into the light having the longer emission wavelength. In other words, by respectively disposing the quantum dots at different levels, the embodiment of the present invention is able to adjust the content of any one population of the quantum dots without affecting the emission intensity of the quantum dots of other colors. Further, since the light emitted by the quantum dots having the shorter emission wavelength has undergone one light conversion, the present invention is able to avoid the reduction in the light conversion efficiency caused by a second light conversion. That is, the backlight module of the embodiment of the present invention is able to increase the light conversion efficiency, thereby improving the energy efficiency and the display brightness of the display device. As such, the embodiment of the present invention is able to simplify the adjustment of the white point while increasing the energy efficiency of the display device. The embodiment of the present invention achieves the reduction of labor costs and, at the same time, increase the energy efficiency and display brightness of the display device without sacrificing the color gamut and optical characteristics of the display device.

In order to make the aforementioned and other features and advantages of the invention more comprehensible, several embodiments accompanied with figures are described in detail below.

### BRIEF DESCRIPTION OF THE DRAWINGS

FIG. 1 is a schematic cross-sectional view of a display device according to a first embodiment of the invention.

FIG. 2A is an enlarged schematic view of one light conversion layer of FIG. 1.

FIG. 2B is an enlarged schematic view of another light conversion layer of FIG. 1.

FIG. 3 is an enlarged schematic view of a quantum dot layer according to an embodiment of the invention.

FIG. 4 is a schematic cross-sectional view of a display device according to a second embodiment of the invention.

FIG. 5 is a graph showing the relationship between the luminous intensity and the wavelength of the light conversion layer of Experimental Example 1 and Comparative Example 1.

FIG. 6A is a graph showing the relationship between the luminous intensity and the wavelength of the light conversion layer of Comparative Examples 1 and 2.

FIG. 6B is a graph showing the relationship between the luminous intensity and the wavelength of the light conversion layer of Comparative Examples 2 and 3.

FIG. 7 is a chromaticity diagram showing the light conversion layer of Experimental Example 1 and Comparative Examples 1 to 3.

### DETAILED DESCRIPTION OF DISCLOSED EMBODIMENTS

The invention is illustrated more comprehensively referring to the drawings of the embodiments. However, the invention may be embodied in many different forms and should not be construed as limited to the embodiments set forth herein. Thicknesses of layers and regions in the drawings may be enlarged for clarity. The same or similar reference numerals represent the same or similar components, and are not repeated in the following paragraphs.

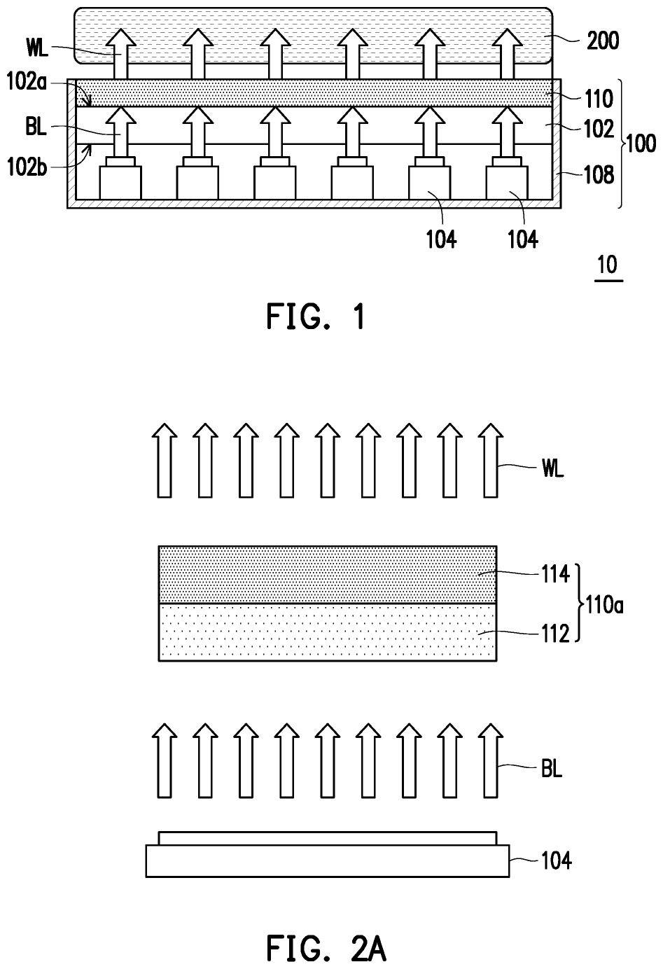

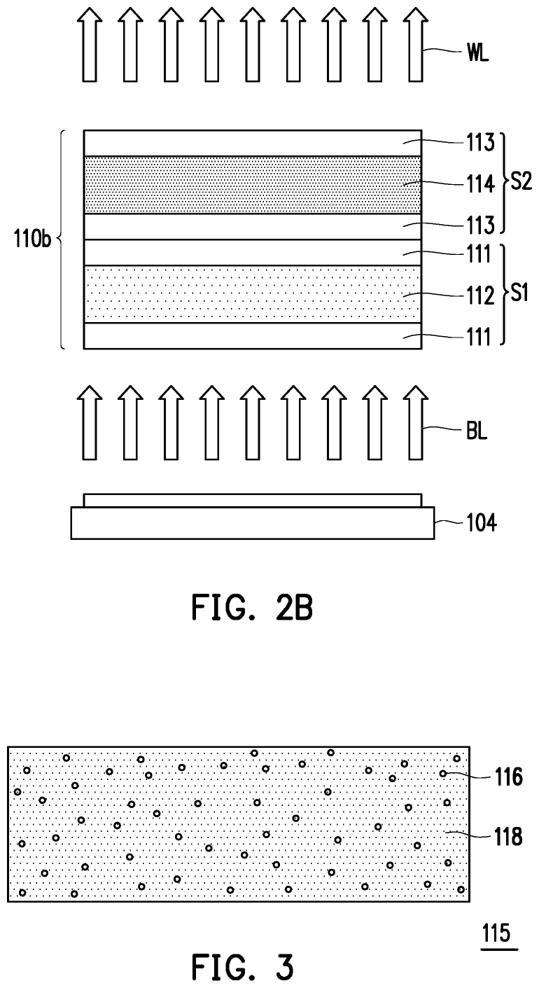

FIG. 1 is a schematic cross-sectional view of a display device according to a first embodiment of the invention. FIG. 2A is an enlarged schematic view of one light conversion layer of FIG. 1. FIG. 2B is an enlarged schematic view of another light conversion layer of FIG. 1.

Referring to FIG. 1, in a first embodiment of the present invention, a display device 10 includes a backlight module 100 and a display panel 200. The backlight module 100 is disposed at one side of the display panel 200 (e.g., a lower side of the display panel 200). In some embodiments, the display panel 200 may be, but is not limited to, a liquid crystal display panel. The composition and arrangement of the liquid crystal display panel described above are well known to those of ordinary skill in the optical arts and will not be described in detail herein.

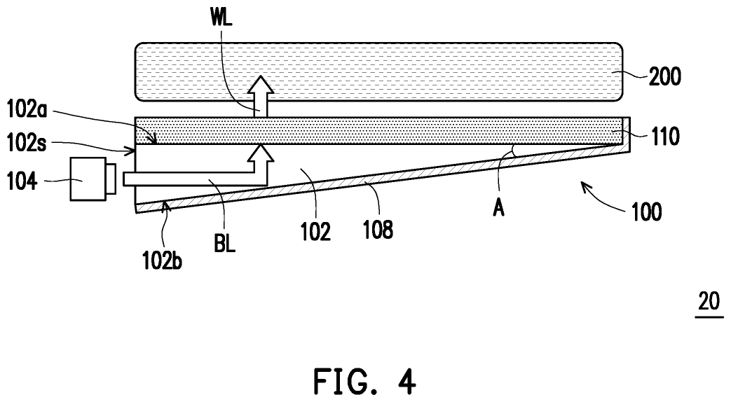

In some embodiments, the backlight module 100 includes a light guide plate 102, a plurality of light sources 104, a light conversion layer 110, and a reflective layer 108. The light guide plate 102 has a light-emitting surface 102a and a light-incident surface 102b disposed opposite to each other. In the present embodiment, as shown in FIG. 1, the light guide plate 102 has a rectangular shape in cross-section. In alternative embodiments, the light guide plate 102 may also have a rectangular shape (as shown in FIG. 4), a trapezoidal shape or other suitable shape in cross-section. In an embodiment, the medium of the light guide plate 102 may include transparent plastic, glass or a material capable of guiding light. In alternative embodiments, the light guide plate 102 may be poly(methyl methacrylate) (PMMA), polycarbonate (PC), polyethylene terephthalate (PET), polyimide (PI) or other suitable material. In other embodiments, the light guide plate 102 may be a light diffuser plate having a uniform haze, and the light beam incident from the light-incident surface 102b is diffused and uniformly led out of the light-emitting surface 102a of the light diffuser plate. Herein, the “haze” refers to a percentage of light that deviates from the incident beam by greater than 2.5 degrees when passing through a transparent medium, and can be used for the evaluation of a light scattering state of a transparent medium. That is, the higher the haze of the transparent medium, the lower the gloss and the transparency (or distinctness of image) thereof. In contrast, the lower the haze of the transparent medium, the higher the gloss and the transparency (or distinctness of image) thereof.

As shown in FIG. 1, the light sources 104 may emit light. In the present embodiment, the light sources 104 are disposed at the light-incident surface 102b of the light guide plate 102 to form a direct-lit structure. In an embodiment, the light sources 104 may be a light emitting diode (LED), or other suitable light emitting element. The light sources 104 may emit white light or light (e.g., blue light, red light, etc.) having a specific wavelength. In the case of blue light, for example, the blue light BL emitted by the light sources is optically coupled to the light guide plate 102 and transmits through the light guide plate 102 to arrive at the light conversion layer 110. The blue light BL emitted from the light sources 104 is then partially converted into a red light and a green light by the light conversion layer 110, so that the blue light BL, the red light and the green light are mixed together to form a white light WL, which then transmits to the display panel 200 over the light conversion layer 110.

The reflective layer 108 is disposed on the back surface 102b of the light guide plate 102 to reflect the light BL emitted from the light sources 104 into the light conversion layer 110, thereby improving the luminous efficiency of the light conversion layer 110. In one embodiment, a material of the reflective layer 108 includes a reflective metallic material, and examples thereof include gold, silver, aluminum, copper or other suitable metallic material.

The light conversion layer 110 is disposed on the light-emitting surface 102a of the light guide plate 102. In an embodiment, as shown in FIG. 2A, the light conversion layer 110a includes a first layer 112 and a second layer 114 that are in direct contact with each other. The first layer 112 is adjacent to the light sources 104 and includes a plurality of first quantum dots. The second layer 114 includes a plurality of second quantum dots and is further away from the light sources 104 than the first layer 112. That is, the first layer 112 is disposed between the light sources 104 and the second layer 114.

It is noted that the first quantum dots have an emission wavelength greater than that of the second quantum dots, which can prevent the first quantum dots from absorbing the light emitted by the second quantum dots and reducing the light conversion efficiency of the light conversion layer 110. For example, the first quantum dots may be red quantum dots, and the second quantum dots may be green quantum dots. In general, in addition to absorbing blue light, the red quantum dots also absorb the green light emitted by the green quantum dots and convert them into red light. If the red quantum dots and the green quantum dots are mixed in the same layer, the red quantum dots can absorb the green light and decrease the red light conversion efficiency due to undergoing two conversions (i.e., blue light→green light→red light). On the other hand, the light conversion layer 110 has a lower green light intensity due to the green light emitted by the green quantum dots is absorbed by the red quantum dots. In the embodiment, the red quantum dots and the green quantum dots are respectively disposed in layers at levels. The red quantum dots are disposed in the first layer 112 (hereinafter referred to as the red quantum dot layer 112) close to the light sources 104, and the green quantum dots are disposed in the second layer 114 (hereinafter referred to as the green quantum dot layer 114) far from the light sources 104. The blue light BL first passes through the red quantum dot layer 112 and converts a portion of the blue light BL into a red light. Subsequently, another portion of the blue light BL and the red light pass through the green quantum dot layer 114 to convert another portion of the blue light BL into a green light. Since the green light does not pass through the red quantum dot layer 112, the red quantum dots are prevented from absorbing the green light to perform a second light conversion, where the second light conversion can decrease the light conversion efficiency. In addition, since the green quantum dots cannot absorb the red light and the green light will not pass through the red quantum dots, the emission intensity of both the red quantum dots and the green quantum dots are not affected. Therefore, in the embodiment, by disposing the red quantum dot layer 112 and the green quantum dot layer 114 at different levels, the light conversion efficiency of the quantum dot layer 110 is not only increased, but also the emission intensities of the red and green quantum dots are also maintained. As such, the present embodiment can increase the light conversion efficiency of the light conversion layer 110, thereby enhancing the energy efficiency and display brightness of the display device including the same.

Furthermore, in a conventional technique in which multiple populations of quantum dots are mixed and disposed in a single light conversion layer, the adjustment of the concentration of one population of quantum dots (e.g., the red quantum dot), the intensities of all colors (e.g., red light, green light, blue light, etc.) will be affected. This is because as the intensity of red light is increased due to the increase in the concentration of the red quantum dots, more blue and green lights will also be absorbed by the increased red quantum dots, thereby reducing the intensity of the blue and green light. On the other hand, when the intensity of the green light increases due to the increase in the concentration of the green quantum dots, more blue light is absorbed by the green quantum dots and converted into green light. That is, the blue light is reduced and the green light is increased. However, the increased green light is absorbed by the red quantum dots and converted into red light, thereby increasing the intensity of the red light. Therefore, changing one of either the concentration of the red quantum dots or the concentration of the green quantum dots, both red and green light intensities will be affected simultaneously due to this interaction. In contrast, in the present embodiment, the red quantum dot layer 112 and the green quantum dot layer 114 are respectively disposed at different levels, which can break this interaction between the different populations of the quantum dots and avoid the situation where changing the content of one population of quantum dots can affect all light intensities emitted. Therefore, the present embodiment can adjust the concentration of any one population of the quantum dots without affecting the emission intensity of the quantum dots having other colors. That is to say, in the present embodiment, the configuration of the light conversion layer can simplify the adjustment of the white point to accurately exhibit the desired color point and optical characteristics.

Although the first layer 112 illustrated in FIG. 2A is in direct contact with the second layer 114, the present invention is not limited thereto. In other embodiments, the first layer 112 may not directly contact the second layer 114. In another embodiment, as shown in FIG. 2B, substrates 111 and 113 may be disposed between the first layer 112 and the second layer 114 to separate the first layer 112 from the second layer 114. In some embodiments, a single-layer substrate (e.g., a single-layer substrate 111), a two-layer substrate (e.g., two substrates 111 and 113), or a multi-layer substrate may be disposed between the first layer 112 and the second layer 114 to separate the first layer 112 from the second layer 114. Specifically, the first layer 112 may be sandwiched between two first substrates 111 to form a first stack S1, and the second layer 114 may be sandwiched between two second substrates 113 to form a second stack S2. The second stack S2 is disposed on the first stack S1 to form the light conversion layer 110b. In some embodiments, the substrates 111 and 113 may include polyethylene terephthalate (PET), epoxy, silicone, acryl, or the like. In another embodiment, the substrates 111 and 113 may have the same material or different materials. In still another embodiment, the substrates 111 and 113 may be optical films having other optical properties, such as a brightness enhancement film, a polarizing film, a scattering film, and a light diffuser film. In alternative embodiments, the substrate 111 and 113 may include a barrier layer (e.g., a diamond-like carbon thin film, a silicon oxide layer, a titanium oxide layer, an aluminum oxide layer, a silicon nitride layer, or the like) therein, so as to effectively block the external environmental factors such as moisture, oxygen, volatile substances and so on. In other embodiments, the substrates 111 and 113 may also not include a barrier layer therein.

In addition, although only the single first layer 112 and the single second layer 114 are illustrated in FIG. 2A and FIG. 2B, the present invention is not limited thereto. In other embodiments, as long as the quantum dots having a longer emission wavelength are closer to the light sources 104 than the quantum dots having a shorter emission wavelength, the first layer 112 or the second layer 114 may be multi-layer quantum dot layers, and each quantum dot layer may also include a plurality of quantum dots with one or more colors. In alternative embodiments, the light conversion layer 110a illustrated in FIG. 2A may further include two substrates (not shown) sandwiching the first layer 112 and the second layer 114 in direct contact with each other.

FIG. 3 is an enlarged schematic view of a quantum dot layer according to an embodiment of the invention. In the following embodiments, a quantum dot layer 115 of FIG. 3 may be, but is not limited to, the first layer 112 or the second layer 114 illustrated in FIGS. 2A and 2B.

Specifically, as shown in FIG. 3, the quantum dot layer 115 includes a luminescent material 116 dispersed and embedded in a resin material 118. In one embodiment, the content of the luminescent material 116 is 0.01 wt % to 15 wt %. In the present embodiment, the luminescent material 116 includes a plurality of quantum dots. The quantum dots include a core, a core-shell, a core-alloy layer-shell, or a combination thereof. Particle size or dimension of the quantum dots may be adjusted according to needs (e.g., to emit visible lights of different colors), and the invention is not limited thereto. For example, the first layer 112 may be a red quantum dot layer and the second layer 114 may be a green quantum dot layer.

In one embodiment, said “core” may be, for example, at least one selected from the group consisting of CdS, CdSe, CdTe, ZnS, ZnSe, ZnTe, HgS, HgSe, HgTe, GaN, GaP, GaAs, InP, InAs, InSb, AlN, AlP, AlAs, AlSb, SiC, Fe, Pt, Ni, Co, Al, Ag, Au, Cu, FePt, Si, Ge, PbS, PbSe, PbTe and alloys thereof. In one embodiment, said “shell” is, for example, at least one selected from the group consisting of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, PbTe and alloys thereof. Said core or said shell may be selected according to different needs, and the invention is not limited thereto.

In one embodiment, the content of the resin material 118 is 85 wt % to 99.99 wt %. In some embodiments, the resin material 118 may be acrylic resin, epoxy, silicone, or a combination thereof. Specifically, the resin material 118 is an acrylate polymer which is prepared from a precursor. The precursor includes: 30 wt % to 50 wt % of a first acrylate monomer, 15 wt % to 30 wt % of a second acrylate monomer, 5 wt % to 30 wt % of a surfactant having a thiol group, 5 wt % to 20 wt % of a cross-linker, and 1 wt % to 2 wt % of an initiator. In alternative embodiments, the content of the surfactant is less than the content of the first acrylate monomer. In some embodiments, the first layer 112 and the second layer 114 may include the precursors made of the same material or different materials. In other embodiments, the first layer 112 and the second layer 114 may include the luminescent material 116 and the resin material 118 with the same content or different contents.

In one embodiment, the first acrylate monomer may have a molecular weight ranging from 100 to 1,000. The first acrylate monomer may be selected from the group consisting of methyl methacrylate, ethyl methacrylate, isopropyl methacrylate, n-butyl methacrylate, isobutylmethacrylate, tert-butyl methacrylate, n-amyl methacrylate, isoamyl methacrylate, n-hexyl methacrylate, tridecyl methacrylate, stearyl methacrylate, decyl methacrylate, dodecyl methacrylate, methoxydiethylene glycol methacrylate, phenyl methacrylate, phenoxyethyl methacrylate, tetrahydrofurfuryl methacrylate, tert-butylcyclohexyl methacrylate, behenyl methacrylate, dicyclopentanyl methacrylate, dicyclopentenyloxyethyl methacrylate, 2-ethylhexylmethacrylate, octyl methacrylate, isooctylmethacrylate, hexadecyl methacrylate, octadecyl methacrylate, benzyl methacrylate, 2-phenylethylmethacrylate, 2-phenoxyethyl acrylate, cyclic trimethylolpropane formal acrylate, cyclohexyl methacrylate, and 4-tert-butylcyclohexylacrylate. However, the invention is not limited thereto. In other embodiments, a suitable first acrylate monomer may be selected based on the literature according to different needs.

In one embodiment, the second acrylate monomer may have a molecular weight ranging from 200 to 10,000. In some embodiments, the molecular weight of the second acrylate monomer is greater than the molecular weight of the first acrylate monomer. In alternative embodiments, the second acrylate monomer is different from the first acrylate monomer. The second acrylate monomer is, for example, neopentyl glycol propoxylate diacrylate, diethylene glycol dimethacrylate, 1,6-hexanedioldiacrylate, 1,6-hexanediol dimethacrylate, 1,12-dodecanediol dimethacrylate, or triallyl isocyanurate. However, the invention is not limited thereto. In other embodiments, a suitable second acrylate monomer may be selected based on the literature according to different needs.

In one embodiment, the surfactant has at least two thiol groups. In other embodiments, the surfactant may be a compound having multi-thiol groups.

In alternative embodiments, the surfactant is a compound represented by formula (I), formula (II) or formula (III) below:

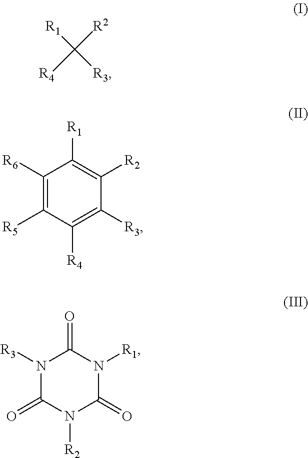

wherein R₁, R₂, R₃, R₄, R₅ and R₆ are the same as or different from one another, and are independently selected from the group consisting of hydrogen, C₁ to C₂₀ alkyl, C₂ to C₂₀ alkenyl, C₂ to C₂₀ alkynyl, C₁ to C₂₀ hydroxy alkyl, C₁ to C₂₀ alkyl ester, C₂ to C₂₀ alkyl ketone, C₁ to C₂₀ alkyl thioether and C₁ to C₂₀ alkoxy, wherein at least two of R₁ to R₄ have a thiol group when the surfactant is the compound of formula (I); at least two of R₁ to R₆ have a thiol group when the surfactant is the compound of formula (II); and at least two of R₁ to R₃ have a thiol group when the surfactant is the compound of formula (III).

In one embodiment, C₁ to C₂₀ alkyl may be linear or branched alkyl. Examples of the Ci to C₂₀ alkyl include methyl, ethyl, propyl, n-butyl, isobutyl, pentyl, hexyl, heptyl, or the likes; however, the invention is not limited thereto.

In one embodiment, C₂ to C₂₀ alkenyl may be linear or branched alkenyl. Examples of the C₂ to C₂₀ alkenyl include ethenyl, propenyl, butenyl, pentenyl, hexenyl, heptenyl, or the likes; however, the invention is not limited thereto.

In one embodiment, C₂ to C₂₀ alkynyl may be linear or branched alkynyl. Examples of the C₂ to C₂₀ alkynyl include ethynyl, propynyl, butynyl, pentynyl, hexynyl, heptynyl, or the likes; however, the invention is not limited thereto.

In one embodiment, C₁ to C₂₀ hydroxy alkyl may be linear or branched hydroxy alkyl. Examples of the C₁ to C₂₀ hydroxy alkyl include hydroxy methyl, hydroxy ethyl, hydroxy propyl, hydroxy butyl, hydroxy pentyl, hydroxy hexyl, hydroxy heptyl, or the likes; however, the invention is not limited thereto.

In one embodiment, C₁ to C₂₀ alkyl ester may be linear or branched alkyl ester. Examples of the C₁ to C₂₀ alkyl ester include methyl methanoate, methyl ethanoate, ethyl propanoate, ethyl butanoate, methyl pentanoate, methyl hexanoate, methyl heptanoate, or the likes; however, the invention is not limited thereto.

In one embodiment, C₂ to C₂₀ alkyl ketone may be linear or branched alkyl ketone. Examples of the C₂ to C₂₀ alkyl ketone include ethyl propanone, ethyl butanone, methyl pentanone, methyl hexanone, methyl heptanone, methyl octanone or the likes; however, the invention is not limited thereto.

In one embodiment, C₁ to C₂₀ alkyl thioether may be linear or branched alkyl thioether. Examples of the C₁ to C₂₀ alkyl thioether include dimethylsulfanyl, diethylsulfanyl, ethylpropylsulfanyl, methyl butylsulfanyl, butylsulfanyl, methyl pentylsulfanyl, methyl hexylsulfanyl, methyl heptylsulfanyl or the likes; however, the invention is not limited thereto.

In one embodiment, C₁ to C₂₀ alkoxy may be linear or branched alkoxy. Examples of the C₁ to C₂₀ alkoxy include methoxy, ethoxy, propoxy, butoxy, pentyloxy, hexyloxy, heptyloxy, or the likes; however, the invention is not limited thereto.

In another embodiment, the surfactant is represented by the above formula (I), formula (II) or formula (III), wherein at least two of R₁ to R₆ are C₁ to C₂₀ alkyl having a thiol group. For example, R₁ and R₂ are both C₁ to C₂₀ alkyl having a thiol group; R₁, R₂ and R₃ are all C₁ to C₂₀ alkyl having a thiol group; R₁, R₂, R₃ and R₄ are all C₁ to C₂₀ alkyl having a thiol group; R₁, R₃, R₄ and R₆ are all C₁ to C₂₀ alkyl having a thiol group; or R₁, R₄, R₅ and R₆ are all C₁ to C₂₀ alkyl having a thiol group. However, the present invention is not limited thereto. In alternative embodiments, the above C₁ to C₂₀ alkyl may also be replaced by C₂ to C₂₀ alkenyl, C₂ to C₂₀ alkynyl, C₁ to C₂₀ hydroxy alkyl, C₁ to C₂₀ alkyl ester, C₂ to C₂₀ alkyl ketone, C₁ to C₂₀ alkyl thioether, or C₁ to C₂₀ alkoxy.

In specific embodiments, the surfactant may be a compound selected from the group consisting of 1,3-propanedithiol, 2,2′-thiodiethanethiol, 1,3-benzenedithiol, 1,3-benzenedimethanethiol, glycol dimercaptoacetate, trimethylolpropane trimercaptoacetate, tris[2-(3-mercaptopropionyloxy)ethyl]isocyanurate; however, the invention is not limited thereto.

In one embodiment, the surfactant has a molecular weight ranging from 100 to 1,000. In alternative embodiments, the surfactant has a molecular weight ranging from 100 to 500.

It should be noted that the surfactant has a plurality of thiol groups which facilitate the uniform dispersion of the luminescent material 116 (hereinafter referred to as quantum dots 116) and prevent the quantum dots 116 from aggregation. Additionally, the surfactant may also increase the resistance of the quantum dots 116 to external environmental factors. In particular, since the surfactant has the plurality of thiol groups, not all of the thiol groups interact with the quantum dots 116, and the thiol groups not interacting with the quantum dots 116 may cross-link with other compounds thereby forming a relatively stable optical film. In other words, in the present embodiment, a portion of the thiol groups of the surfactant interact with the quantum dots 116, while another portion of the thiol groups of the surfactant cross-link with other compounds. Therefore, compared to a conventional optical film (which uses an amine compound), the optical film formed in the present embodiment has improved stability. Therefore, even if the optical film is irradiated with light or contacts external interfering factors, such as water, moisture, oxygen or the like, the external interfering factors do not affect the efficacy of the optical film. Thus, the need for a barrier material is effectively eliminated.

In one embodiment, the cross-linker may be, but is not limited to, a suitable acrylic-based compound having a molecular weight ranging from 100 to 2,000. Examples of the cross-linker include 4-hydroxybutyl acrylate, 4-hydroxybutyl acrylate glycidylether, diallyl phthalate, 1,4-cyclohexane dimethanol monoacrylate, trimethallyl isocyanurate, or [2[1,1-dimethyl-2[(1-oxoallyl)oxy]ethyl]-5ethyl-1,3dioxan-5-yl]methyl acrylate.

In one embodiment, the initiator may be a photoinitiator or a thermal initiator. In the present embodiment, the example used in the optical composite material 10 may be a photoinitiator. That is, the optical composite material 10 of the present embodiment may be obtained within the minimum curing time simply by irradiation with light. In other embodiments, examples of the initiator include, but not limited to, benzoin ethers, benzyl ketals, a-dialkoxy-acetophenones, a-amino-alkylphenones, acylphosphine oxides, benzophenones, thioxanthones, titanocenes, 1-hydroxy-cyclohexyl-phenyl-ketone, 2-hydroxy-2-methyl-1-phenyl-1-propanone, 2-hydroxy-1[4-(2-hydroxyethoxy)phenyl]-2-methyl-1-propanone, methylbenzoylformate, oxy-phenyl-acetic acid, 2-[2 oxo-2 phenyl-acetoxy-ethoxy]-ethyl ester, oxy-phenyl-acetic 2-[2-hydroxy-5 ethoxy]-ethyl ester, alpha-dimethoxy-alpha-phenylacetophenone, 2-benzyl-2-(dimethylamino)-1[4-(4-morpholinyl)phenyl]-1-butanone, 2-methyl-1-[4-(methylthio)phenyl]-2-(4-morpholinyl)-1-propanone, or diphenyl(2,4,6-trimethylbenzoyl)phosphine oxide.

In one embodiment, the quantum dot layer 115 further includes particles with a content of less than the sum content of the luminescent material 116 and the resin material 118. The particles are selected from the group consisting of titanium dioxide, zinc oxide, zinc sulfide, silica, zirconium oxide, antimony trioxide, alumina, Lonsdaleite, diamond-like carbon, bismuth oxychloride (BiOCl), barium titanate, potassium lithium niobate, lithium niobate, lithium tantalate, proustite, polyfluoroolefin, polycarbonate, polystyrene, and an arbitrary combination thereof. The particles may have a particle size ranging from 0.02 μm to 30 μm. The particles may be used to scatter incident light and to increase the chance of the incident light reacting with the luminescent material 116, thereby enhancing absorption and conversion efficiency of the luminescent material 116 for the incident light. The particles may also be used to scatter emitted light and to increase the chance of the emitted light interacting with a surface of the quantum dot layer 115, thereby enhancing the luminous efficiency of the quantum dot layer 115.

FIG. 4 is a schematic cross-sectional view of a display device according to a second embodiment of the invention.

Referring to FIG. 4, a display device 20 of the second embodiment is similar to the display device 10 of the first embodiment, the material and arrangement have been described in detail in the above paragraphs, and thus will not be described again. A difference between the above two lies in that the light source 104 of the display device 20 is disposed at a light-incident surface (side surface) 102s of the light guide plate 102 to form an edge-lit structure. Specifically, the light guide plate 102 has a light-emitting surface 102a, a back surface 102b, and a light-incident surface 102s, wherein the light-incident surface 102s is connected to the light-emitting surface 102a and the back surface 102b. In one embodiment, as shown in FIG. 4, the light guide plate 102 has a triangular shape in cross-section, and an acute angle A is formed between the light-emitting surface 102a of the light guide plate 102 and the extending direction of the back surface 102b. After the blue light BL emitted from the light source 104 enters the light guide plate 102, the blue light BL transmits through the light guide plate 102 by total reflection of the light guide plate 102, and reaches the light conversion layer 110 via the light-emitting surface 102a. The blue light BL emitted from the light source 104 is then partially converted into red light and green light by the light conversion layer 110, and the blue light BL, the red light, and the green light are mixed to become the white light WL that transmits to the liquid crystal panel 200 on the light conversion layer 110.

In other embodiments, the light guide plate 102 may be a light diffuser plate whose haze gradually increases along a direction from the light-incident surface 102b to the light-emitting surface 102a. Herein, the “haze” refers to a percentage of light that deviates from the incident beam by greater than 2.5 degrees when passing through a transparent medium, and can be used for the evaluation of a light scattering state of a transparent medium. That is, the greater the haze of the transparent medium, the less the gloss and the transparency (or distinctness of image) thereof. In contrast, the less the haze of the transparent medium, the greater the gloss and the transparency (or distinctness of image) thereof.

Experiment examples of the invention are mentioned below to more specifically describe the invention. However, the materials, methods used and so on as shown in the following experiment examples may be suitably modified without departing from the spirit of the invention. Therefore, the scope of the invention should not be interpreted in a limiting sense using the experiment examples shown below.

### COMPARATIVE EXAMPLE 1

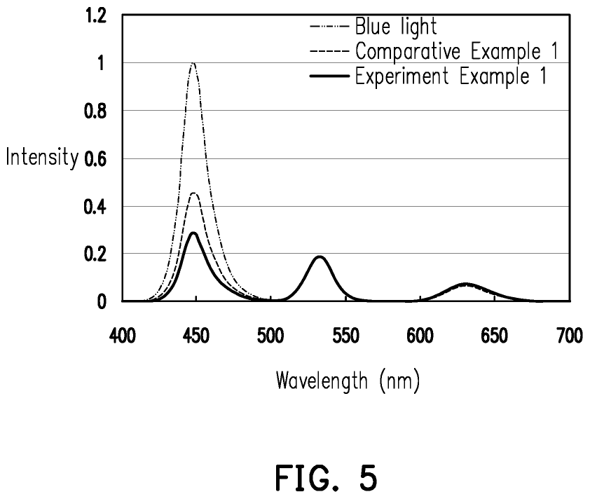

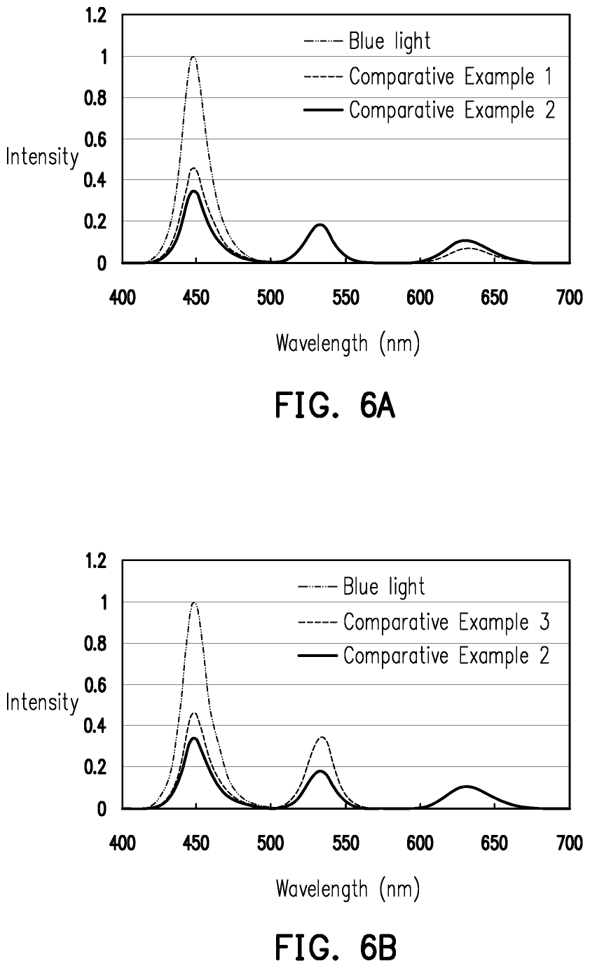

0.06 wt % of red quantum dots (CdSe/ZnS quantum dots) were mixed with a precursor of an acrylate polymer and cured by ultraviolet (UV) light to a red quantum dot layer, thereby forming a light conversion layer with a red single-layer structure. The red single-layer structure is placed in the backlight module 100 of FIG. 1, and a luminometer is used to measure the backlight module including the red single-layer structure. The results are shown in FIG. 5 and FIG. 6A.

### EXPERIMENT EXAMPLE 1

First, 0.06 wt % of red quantum dots (CdSe/ZnS quantum dots) were mixed with a precursor of an acrylate polymer and cured by UV light to a red quantum dot layer. Next, 0.75 wt % of green quantum dots (CdSe/ZnS quantum dots) are mixed with a precursor prepared as an acrylate polymer, coated on the red quantum dot layer, and cured by UV light to form a green quantum dot layer, thereby forming a light conversion layer with a two-color stacked structure. The two-color stacked structure is placed in the backlight module 100 of FIG. 1, wherein the red quantum dot layer is closer to the light source than the green quantum dot layer. Thereafter, the backlight module including the two-color stacked structure was measured by using a luminometer, and the result is shown in FIG. 5.

Referring to FIG. 5, although the two-color stacked structure has the green quantum dot layer, the red light intensity emitted by the two-color stacked structure is substantially equal to the red light intensity of the red single-layer structure. That is to say, when the red quantum dot layer is closer to the light source than the green quantum dot layer, green light generated by the green quantum dots does not reach the red quantum dots and therefore is not absorbed by the red quantum dots. In addition, the green quantum dot layer will only convert blue light to green light, but will not convert red light emitted from the red quantum dots. This result demonstrates that the content of one quantum dot population (i.e., the green quantum dots) in the two-color stacked structure of Experimental Example 1 can be changed without seriously affecting the emission intensities of other quantum dot populations (i.e., the red quantum dots). As such, the two-color stacked structure simplifies the process of adjusting the CIE color coordinates. Herein, the said CIE color coordinates were defined by members of Commission Internationale de L′Eclairage (CIE) in 1931, which defined the color space in a mathematical way.

### COMPARATIVE EXAMPLE 2

0.06 wt % red quantum dots (CdSe/ZnS quantum dots), 0.75 wt % green quantum dots (CdSe/ZnS quantum dots), and a precursor of an acrylate polymer were mixed together and cured by UV light to a light conversion layer with a two-color single-layer structure. Next, the two-color single-layer structure is placed in the backlight module 100 of FIG. 1, and the backlight module including the two-color single-layer structure is measured by using a luminometer, and the results are shown in FIG. 6A and FIG. 6B.

### COMPARATIVE EXAMPLE 3

0.75 wt % of green quantum dots (CdSe/ZnS quantum dots) were mixed with a precursor of an acrylate polymer and cured by UV light to a light conversion layer with a green single-layer structure. The green single-layer structure is placed in the backlight module 100 of FIG. 1, and a luminometer is used to measure the backlight module including the green single-layer structure. The result is shown in FIG. 6B.

Referring to FIG. 6A, the red light intensity of the two-color single-layer structure is greater than the red light intensity of the red single-layer structure. That is to say, the red quantum dots of the two-color single-layer structure not only absorb the blue light, but also absorb the green light emitted by the green quantum dots, and then converts the green light into red light, which results in a second light conversion with lower light conversion rate.

Referring to FIG. 6B, the green light intensity of the two-color single-layer structure is less than the green light intensity of the green single-layer structure. That is to say, in addition to absorbing the blue light, the red quantum dots in the two-color single-layer structure also absorb the green light emitted by the green quantum dots, thereby reducing the intensity of green light.

In addition, as shown in FIG. 6A and FIG. 6B, in the two-color single-layer structure, when either the concentration of the red quantum dots or the concentration of the green quantum dots is changed, the emission intensity of all other quantum dots are affected, thereby complicating the adjustment of white point or the process of adjusting the CIE color coordinates.

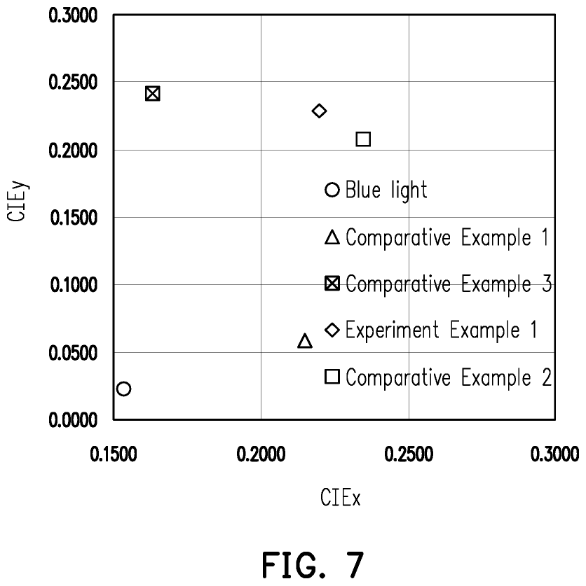

FIG. 7 is a chromaticity diagram showing the light conversion layer of Experimental Example 1 and Comparative Examples 1 to 3.

The two-color stacked structure of Experimental Example 1 is formed by respectively disposing the red quantum dot layer and the green quantum dot layer at different levels, wherein the red quantum dot layer is closer to the light source than the green quantum dot layer, thus the green light does not pass through red quantum dot layer, effectively preventing the red quantum dots from absorbing green light and performing a second light conversion. Referring to FIG. 7, CIE x (which indicates red light) of the two-color stacked structure of Experimental Example 1 is comparable to an CIE x of the red single-layer structure of Comparative Example 1. Furthermore, since the green quantum dot layer of Experimental Example 1 is stacked on the red quantum dot layer, the green light does not pass through and absorbed by the red quantum dot layer nor can the green quantum dots absorb red light. Therefore, as shown in FIG. 7, compared with the red single-layer structure of Comparative Example 1, the stacked structure of Experimental Example 1 has a greater CIE y (which indicates green light), while the CIE x (which indicates red light) remains substantially the same. That is to say, the two-color stacked structure of Experimental Example 1 is able to simplify the process of adjusting the white point or adjusting the CIE color coordinates.

On the other hand, when the red quantum dots and the green quantum dots are mixed in the same layer to form the two-color single-layer structure of Comparative Example 2, the green quantum dots would absorb blue light and are converted into green light, and the said green light is then absorbed again by the red quantum dots to be converted into red light (a second light conversion), thereby reducing the intensity of green light and increasing the proportion of red light in the total light emitted. Therefore, as shown in FIG. 7, the CIE x of the two-color single-layer structure of Comparative Example 2 is larger than the CIE x of the red single-layer structure of Comparative Example 1. That is, compared with the red single-layer structure of Comparative Example 1, the addition of green quantum dots in the two-color single-layer structure of Comparative Example 2 does not just cause the CIE y (which indicates green light) to increase, the CIE x (which indicates red light) will also increase slightly.

In addition, when the green quantum dots and the red quantum dots are mixed in the same layer to form the two-color single-layer structure of Comparative Example 2, the green light emitted by the green quantum dots is absorbed by the red quantum dots, thereby reducing the green light intensity. Therefore, as shown in FIG. 7, the CIE y of the two-color single-layer structure of Comparative Example 2 is less than the CIE y of the green single-layer structure of Comparative Example 3. That is, compared with the green single-layer structure of Comparative Example 3, although the addition of red quantum dots can increase the CIE x (which indicates red light) of the two-color single-layer structure of Comparative Example 2, the CIE y (which indicates green light) will decrease.

As shown in FIG. 7, in the two-color single-layer structure of Comparative Example 2, when either one of the concentration of the red quantum dots or the concentration of the green quantum dots is changed, both CIE x and CIE y will be affected simultaneously. In contrast, in the two-color stacked structure of Experimental Example 1, the red quantum dot layer and the green quantum dot layer are respectively disposed at different levels, which can avoid different populations of quantum dots with different colors affecting each other, thereby preventing simultaneously changing CIE x and CIE y when the content of only one population of quantum dots is changed. In other words, the configuration of the two-color stacked structure of Experimental Example 1 is able to simplify the adjustment of the white point to accurately exhibit the desired color point and optical characteristics.

In summary, in the embodiment of the present invention, different populations of quantum dots having different emission wavelengths are respectively disposed at different levels, so as to prevent the quantum dots with the longer emission wavelength from absorbing the light emitted by the quantum dots with the shorter emission wavelength, thereby preventing a second conversion from being performed which reduces the light conversion efficiency. In other words, the backlight module of the embodiment of the present invention can increase the light conversion efficiency, thereby improving the energy efficiency and display brightness of the display device. In addition, in the embodiments of the present invention, the quantum dots are disposed respectively at different levels which allows the adjustment of the concentration of any one population of quantum dots without affecting the emission intensity of other population of quantum dots with other colors. Therefore, the embodiment of the present invention is able to simplify the adjustment of the white point to accurately present the desired color point and optical characteristics.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A backlight module, comprising:
a light source emitting a light
a light guide plate optically coupled to the light source, and the light transmitting through the light guide plate; and
a light conversion layer disposed over the light guide plate, wherein the light conversion layer comprises:
a first layer, adjacent to the light source and comprises a plurality of first quantum dots; and
a second layer, further away from the light source than the first layer and comprising a plurality of second quantum dots, wherein an emission wavelength of the plurality of first quantum dots is greater than an emission wavelength of the plurality of second quantum dots.

2. The backlight module of claim 1, wherein the first layer is in direct contact with the second layer, and the first layer and the second layer are sandwiched between two substrates.

3. The backlight module of claim 1, further comprising at least one substrate between the first layer and the second layer.

4. The backlight module of claim 3, wherein the at least one substrate is free of a barrier layer.

5. The backlight module of claim 1, further comprising:
two first substrates, the first layer sandwiched between the two first substrates; and
two second substrates, the second layer sandwiched between the two second substrates, wherein one of the two first substrates is in direct contact with an adjacent second substrate.

6. The backlight module of claim 1, wherein the light is a blue light, the plurality of first quantum dots comprise a plurality of red quantum dots, and the plurality of second quantum dots comprise a plurality of green quantum dots.

7. The backlight module of claim 1, wherein the first layer comprises a first resin material, the plurality of first quantum dots are dispersed and embedded in the first resin material, wherein the first resin material is prepared by a first precursor, the first precursor comprises a first surfactant having a thiol group, and wherein
the second layer comprises a second resin material, the plurality of second quantum dots are dispersed and embedded in the second resin material, wherein the second resin material is prepared by a second precursor, the second precursor comprises a second surfactant having a thiol group.

8. The backlight module of claim 7, wherein the first surfactant or the second surfactant has at least two thiol groups.

9. The backlight module of claim 8, wherein the first surfactant or the second surfactant is a compound represented by formula (I), formula (II) or formula (III) below: 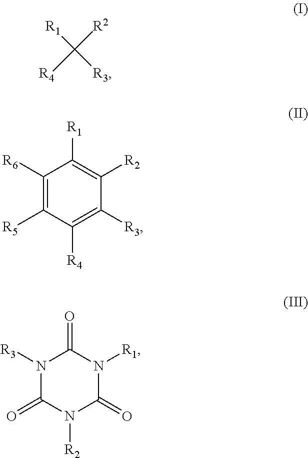
wherein R₁, R₂, R₃, R₄, R₅ and R₆ are the same as or different from one another, and are independently selected from the group consisting of hydrogen, C₁ to C₂₀ alkyl, C₂ to C₂₀ alkenyl, C₂ to C₂₀ alkynyl, C₁ to C₂₀ hydroxy alkyl, C₁ to C₂Oalkyl ester, C₂ to C₂₀ alkyl ketone, C₁ to C₂₀ alkyl thioether and C₁ to C₂₀ alkoxy, wherein at least two of R₁ to R₄ have a thiol group when the first surfactant or the second surfactant is the compound of formula (I); at least two of R₁ to R₆ have a thiol group when the first surfactant or the second surfactant is the compound of formula (II); and at least two of R₁ to R₃ have a thiol group when the first surfactant or the second surfactant is the compound of formula (III).

10. The backlight module of claim 7, wherein the first precursor or the second precursor comprises:
5 wt % to 30 wt % of the first surfactant or the second surfactant having at least two thiol groups;
30 wt % to 50 wt % of a first acrylate monomer;
15 wt % to 30 wt % of a second acrylate monomer;
5 wt % to 20 wt % of a cross-linker; and
1 wt % to 2 wt % of an initiator.

11. The backlight module of claim 1, further comprising:
a reflective layer disposed below the light guide plate to reflect the light into the light conversion layer.

12. A light conversion layer, disposed over a light source, wherein the light conversion layer comprises:
a first layer, adjacent to the light source and comprises a plurality of first quantum dots; and
a second layer, further away from the light source than the first layer and comprising a plurality of second quantum dots, wherein an emission wavelength of the plurality of first quantum dots is greater than an emission wavelength of the plurality of second quantum dots.

13. The light conversion layer of claim 12, wherein the first layer is in direct contact with the second layer, and the first layer and the second layer are sandwiched between two substrates.

14. The light conversion layer of claim 12, further comprising at least one substrate between the first layer and the second layer.

15. The light conversion layer of claim 14, wherein the at least one substrate is free of a barrier layer.

16. The light conversion layer of claim 12, wherein the first layer comprises a first resin material, the plurality of first quantum dots are dispersed and embedded in the first resin material, wherein the first resin material is prepared by a first precursor, the first precursor comprises a first surfactant having a thiol group, and wherein
the second layer comprises a second resin material, the plurality of second quantum dots are dispersed and embedded in the second resin material, wherein the second resin material is prepared by a second precursor, the second precursor comprises a second surfactant having a thiol group.

17. The light conversion layer of claim 16, wherein the first surfactant or the second surfactant has at least two thiol groups.

18. The light conversion layer of claim 16, wherein the first surfactant or the second surfactant is a compound represented by formula (I), formula (II) or formula (III) below: 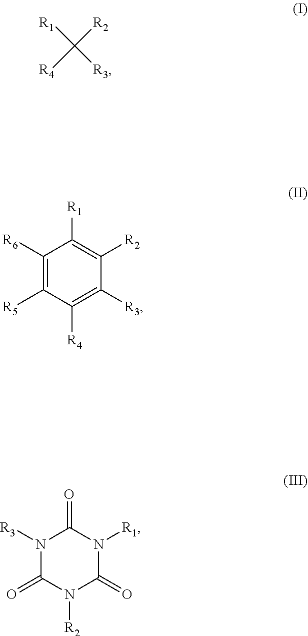
wherein R₁, R₂, R₃, R₄, R₅ and R₆ are the same as or different from one another, and are independently selected from the group consisting of hydrogen, C₁ to C₂₀ alkyl, C₂ to C₂₀ alkenyl, C₂ to C₂₀ alkynyl, C₁ to C₂₀ hydroxy alkyl, C₁ to C₂₀ alkyl ester, C₂ to C₂₀ alkyl ketone, C₁ to C₂₀ alkyl thioether and C₁ to C₂₀ alkoxy, wherein at least two of R₁ to R₄ have a thiol group when the first surfactant or the second surfactant is the compound of formula (I); at least two of R₁ to R₆ have a thiol group when the first surfactant or the second surfactant is the compound of formula (II); and at least two of R₁ to R₃ have a thiol group when the first surfactant or the second surfactant is the compound of formula (III).

19. A display device, comprising:
a display panel; and
a backlight module of claim 1, disposed at one side of the display panel.
